(19) United States
(12) Patent Application Publication
(10) Pub. No.: US 2025/0146899 A1
(43) Pub. Date: May 8, 2025

(54) METHOD FOR CONTROLLING AN OXYGEN TANK FOR AN AIRCRAFT

(71) Applicant: SAFRAN AEROTECHNICS, PLAISIR (FR)

(72) Inventor: Vincent GRETER, MOISSY-CRAMAYEL (FR)

(21) Appl. No.: 18/838,686

(22) PCT Filed: Feb. 20, 2023
(86) PCT No.: PCT/FR2023/050235

§ 371 Date: Aug. 15, 2024

(30) Foreign Application Priority Data
Feb. 28, 2022 (FR) 2201757

(51) Int. Cl. G01M 3/32; B64D 45/00

(52) U.S. Cl. CPC G01M 3/3254; B64D 45/00; B64D 2231/02

(57) ABSTRACT

A method for control of an oxygen tank for aircraft, implemented by a processor onboard the aircraft, where the method includes measuring repeatedly a current value of an oxygen volume in the tank and saving the current value in a database, calculating an average oxygen consumption flow rate during an observation period from current values stored in the database, comparing said average flow rate with a preset average flow-rate limit, detecting a possible state of active oxygen consumption from the tank during the observation period and reporting a leak in the tank, if the average oxygen consumption flow rate is over said preset average flow-rate limit and if no active consumption state was detected during the observation period.

### FIELD OF THE INVENTION

The invention relates to a method for control of an oxygen tank for an aircraft.

### DESCRIPTION OF RELATED ART

The onboard oxygen distribution systems for civil aircraft may operate with pressurized tanks containing molecular oxygen in gaseous form, or else, on some large equipment, with a storage of several chemical compounds suited for forming molecular oxygen on demand, by reaction between them.

In the remainder, the term oxygen indicates molecular oxygen, for simplicity.

For pressurized tank systems, monitoring of the quantity of oxygen in the tank is implemented using temperature and pressure sensors driven by onboard computerization of the aircraft. The remaining quantity of oxygen is generally displayed for the pilot and may also be incorporated in maintenance algorithms for the aircraft in case of modern systems.

The remaining oxygen level is generally classified according to three possible states: full at nominal pressure (typically after refilling), sufficient (over a minimum level for the mission), and insufficient (requires filling before the following mission). A fourth level may exist, reporting that a filling is going to be needed soon, which makes it possible to choose a less inconvenient filling opportunity without waiting to the last moment.

In case of leakage from the tank, such an oxygen volume monitoring system can only report a need for a refill once the quantity of oxygen has significantly dropped, putting the tank in an “insufficient” state. Detection of the leak is only possible through the experience of the operator who notices that the quantity of oxygen is dropping too fast or else that refills are too frequent, or else directly during periodic but infrequent inspection and maintenance operations.

Also, leaks are generally problems which appear progressively and worsen over time, for example because of a connection which is loosening, an aging seal or a crack which spreads. Leaks are then only detected late, when the damage is significant.

Leak detection may therefore take lots of time, in particular several filling cycles of the tank and lead to significant losses, and also mission lengths and delays or cancellation.

### BRIEF SUMMARY OF THE INVENTION

The invention aims to remedy these disadvantages by proposing an early detection method for leaks in the tank, before their condition notably worsens.

For this purpose, the object of the invention is a method for control of an oxygen tank for aircraft, implemented by a processor onboard the aircraft, where the method comprises the following steps:
measuring periodically a current value of an oxygen volume in the tank and saving the current value in a database;
calculating an average oxygen consumption flow rate during an observation period from current values stored in the database;
comparing said average flow rate with a preset average flow-rate limit;
detecting a possible state of active oxygen consumption from the tank during the observation period; and
reporting a leak in the tank, if the average oxygen consumption flow rate is over said preset average flow-rate limit and if no active consumption state was detected during the observation period.

Such a method serves to detect the appearance of a leak in the tank early and to report it to the personnel to repair it before it gets worse.

The average flow-rate limit may in particular vary according to the length of the observation period, and dimensions of the reservoir and the oxygen distribution system.

The active consumption state corresponds to a function of the aircraft driving a notable oxygen consumption from the tank. It may for example involve a preflight functional test (called “Press to Test” or “PTT”), which leads to consumption of a few liters (about 1 to 5 L per pilot station) over a very short time (less than one minute).

It may also involve use of the system during flight (either in preventative use, or in emergency use following an event). Such a use leads to a consumption of several liters per minute throughout the length of use of the system, which may extend for several hours.

The method thus serves to distinguish normal consumption during use of the system from abnormal consumption due to a leak that needs to be identified.

The method may comprise, after powering down and restoring power to the onboard processor, a step of calculation of values of the oxygen volume in the tank that were not measured between powering down and restoring power, using a final measured value before powering down and a first measured value after restoring power.

Such a feature serves to fill in the missing value(s), between the moment of powering down and the moment of restoring power, to be able to continue the observation of the volume despite the interruption when said interruption exceeds the time separating two successive volume measurements.

The values obtained by this interpolation calculation can be used for calculating average and short-term flow rates.

The interpolation may for example be implemented according to an affine function.

The method may comprise steps of:
calculating a short-term flow rate based on the difference between the current value and an immediately preceding value; and
recording the short-term flow rate in the database;
where the step of detecting a possible state of active oxygen consumption from the tank is based on the short-term flow rates recorded in the database.

Such a feature serves to detect in the onboard processor the states of active consumption based on characteristic values of consumption flow rates involved.

The value of the short-term flow rate may be compared to a preset short-term flow-rate limit, and a leak may be reported if the short-term flow-rate value exceeds said short-term flow-rate limit.

This way large and sudden leaks can be detected as quickly as possible.

The preset short-term flow-rate limit may be greater than or equal to 2 L per minute.

Such a flow-rate value, in the absence of active use of the oxygen system, is generally characteristic of an abnormal consumption due to a leak.

The method may comprise the following steps:
measuring the temperature in the tank, or in the neighborhood of the tank, simultaneously with each oxygen volume measurement in the tank; and
calculating, for each calculated average flow rate, a variation of the temperature over the same observation period, and comparison of the temperature variation to a preset temperature limit;
wherein a leak is only reported if the temperature variation is below the preset temperature limit.

When the temperature is not directly measured in the tank, in contact with the oxygen, but in the neighborhood thereof, thermal inertia has to be considered, since it leads to a delay between the actual gas temperature and the measured temperature. The method then uses a larger temperature limit, in order to have a greater tolerance.

Such a feature serves to discriminate between large-volume variations due to a leak and those due to a temperature measurement bias, during a rapid temperature change of the gas in the environment of the reservoir.

The temperature limit is for example less than or equal to 2° C. per hour.

The method may comprise a reinitializations step when an active consumption state or filling of the oxygen tank is detected.

Such a detection may correspond to a variation of volume in the tank over 10% of the maximum capacity of the tank, for example.

Such a feature serves to resume leak detection quickly without the results being scrambled by variations due to the test.

The preset average flow-rate limit may decrease when the length of the observation period increases.

This way finer and finer estimates can be obtained as the analysis period becomes progressively longer.

In that way, the average flow-rate limit may be substantially equal to 2 L/min for an observation period of one hour, and of order 100 mL/min for an observation period longer than six hours.

The method may advantageously comprise a step of detection of support force on the wheels of the aircraft and adjustment of the short-term flow-rate limit, and also, as applicable, of the medium limit and/or of the temperature limit based on the measured support force on the wheels.

Such a feature serves to adjust the limit values used for leak detection as a function of the actual flight phase of the aircraft, in the air or on the ground.

These features may be freely combined with each other and contribute to improving the detection of leaks in the tank and discriminating phenomena which can lead to false detections.

### BRIEF DESCRIPTION OF THE DRAWINGS

FIG. 1 is a schematic, side view of an aircraft equipped with an oxygen tank;

FIG. 2 is a representation of flow-rate calculation steps for a method according to the invention for control of the oxygen tank from FIG. 1;

FIG. 3 is a representation of the leak detection steps from the method from FIG. 2; and

FIG. 4 is a graphic representation of a correction in case of temporary stoppage of the control method.

### DETAILED DESCRIPTION OF THE INVENTION

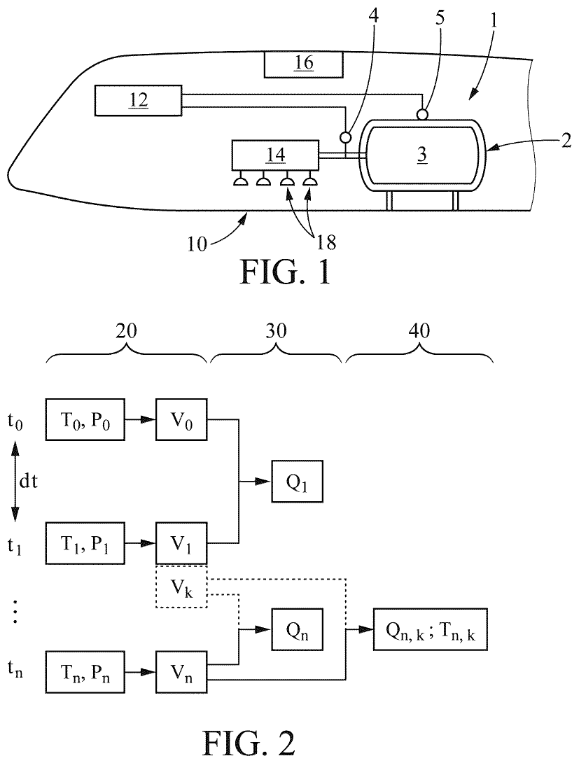

A method for control of a pressurized oxygen tank 1 on board an aircraft 10 is described below with reference to FIGS. 1 and 2.

The oxygen tank 1 is for example a tank comprising a metal wall 2 defining an inner space 3 containing gaseous pressurized molecular oxygen.

The aircraft 10 is for example an airplane, for example an airliner, or else a helicopter.

The aircraft 10 comprises an onboard processor 12 and an oxygen distribution system 14 driven by said onboard processor 12 and connected to the tank 1.

The oxygen distribution system 14 is for example suited for distributing oxygen from the tank 1 to the occupants through masks 18 in a known way in case of failure of the main pressurization system 16 of the aircraft 10.

The onboard processor 12 is also configured for implementing the control method for the tank 1 according to the invention.

For this purpose, the tank 1 is provided with means for measurement of the volume of oxygen contained in the tank connected to the outboard processor 12. The measurement means comprise for example at least one pressure sensor 4 suited for measuring the gas pressure in the internal volume 3 of the tank 1 and at least one temperature sensor 5.

The temperature sensor 5 may be placed directly in the internal volume 3 of the tank 1, and is also suited for directly measuring the temperature of the gas in the tank 1, or else outside and in the neighborhood of the tank 1, for example against the wall 2.

The temperature measurement may then comprise a bias considering the thermal inertial of the gas inside the tank 1.

The onboard processor 12 is configured for deducing the volume of oxygen contained in the tank 1 based on measured pressure and temperature values, and contains a database in which to save the measured values.

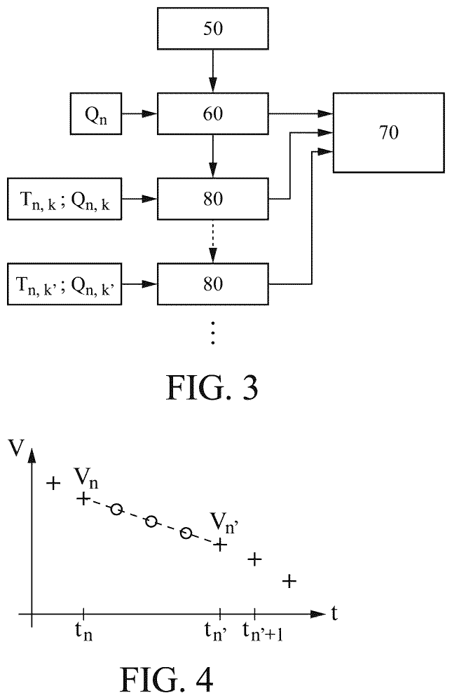

The method, shown schematically in FIGS. 2 and 3, comprises a periodic step of measurement 20 of the volume of oxygen contained in the tank 1 implemented by the onboard processor 12 by means of the measurement means.

The method also comprises a step of measuring 25 a temperature Tₙ in the tank 1 or in the neighborhood of the tank 1 for each measurement 20 of the volume Vₙ of oxygen in the tank 1.

The temperature and volume measurements start on launching the method, for example when powering up the onboard processor 12, and the corresponding moment is noted t₀.

The measurement moments, noted tₙ, are separated by a time dt, and the volume value Vₙ is measured as described above at each of the moments tₙ.

Each measured volume value Vₙ is stored in the database.

The time dt separating two successive volume measurements is substantially constant, and is for example equal to one hour.

The method comprises, at each measurement step 20 a volume value Vₙ, a step of determination 30 of the short-term oxygen consumption flow rate Qₙ at the moment tₙ, calculated from the difference Vₙ−Vₙ₋₁. The short-term flow rate Qₙ is therefore a flow rate measured over a single period separating two successive measurements, and also depends on the time dt between two measurements.

The method also comprises steps for determination 40 of at least one average flow rate Q_{n,k}, where each average flow rate is calculated over an observation period comprising k periods, with k greater than one.

For example, a first average flow rate Q_{n,k} over k=2 consecutive periods and a second average flow rate Q_{n,k}′ over k′=5 consecutive periods may be calculated.

For each average flow rate Q_{n,k} calculated, the method comprises the calculation of a temperature variation for T_{n,k} over the corresponding observation period.

The method comprises a step of detection 50 of an active consumption state of the oxygen system 14, in order to distinguish normal high consumption situations from abnormal situations.

The detection 50 of active consumption is advantageously based on short-term flow-rate values Qn stored in the database.

If active consumption is detected, no leak can be detected over a time comprising said active consumption.

Advantageously, the method is then reinitialized after said active consumption.

The method then comprises a step of comparison 60 of the short-term flow rate Qₙ with a preset short-term flow-rate limit so as to detect an abnormal oxygen consumption.

The short-term flow-rate limit is for example equal to 2 L/min (liters per minute under standard conditions of temperature and pressure), or greater.

Should the measured flow rate be over the short-term limit, and if no active consumption state was detected, the high consumption is probably due to a leak, and the onboard processor 12 reports this leak to the onboard personnel during a reporting step 70.

The method then comprises a comparison step 80 for each average flow rate Q_{n,k} and Q_{n,k}′ associated with a respective observation period.

The average flow rate Q_{n,k} is then compared to an average flow-rate limit different from the short-term flow-rate limit, and in particular lower, for detecting an abnormal oxygen consumption.

The average flow-rate limit is for example below 1.5 L/min for a two-hour observation period.

The average flow-rate limit advantageously goes down when the length of the observation period increases.

For example, over an observation period greater than six hours, the average flow-rate limit may be less than or equal to 200 mL/min.

Advantageously, each comparison step 80 comprises a substep of verification of the temperature variations over the observation period. The temperature variation T_{n,k} is compared to a preset temperature limit, and the leak is only reported if the temperature variation T_{n,k} is below said preset temperature limit. Otherwise, the volume variation may be related to thermal expansion and not a leak.

Advantageously, the method comprises a step of measurement of a support force on the wheels of the aircraft 10 and adjustment of the average flow-rate limit, and also, as applicable, of the temperature limit based on the measured support force on the wheels.

This serves to distinguish whether the aircraft is on the ground or in-flight, and to adjust the limits accordingly.

For example, for a flight over six hours long that had good ambient temperature stability (which is generally the case during a flight), the method is able to distinguish leaks of order 0.1 L/min.

Finally, as shown in FIG. 4, the method may comprise, in case of temporary interruption of the measurements, a step of interpolation of the measured volumes.

For example, if the volume measurements are interrupted during the moments tₙ and tₙ′, for example because of a loss of power to the onboard processor 12, the missing measurements between tₙ and tₙ′ (marked with circles in FIG. 3) are filled in by linear interpolation between the last value measured before tₙ and the first value measured after tₙ′.

In that way, an abnormal behavior may be detected quickly, even in case of temporary power loss to the onboard processor.

When a pressure test of the oxygen distribution system 14 is detected, the method is reinitialized at the end of said test by redoing a first volume measurement V₀ at a new moment t₀.

In that way, the significant oxygen consumption during the test does not disrupt the leak detection method.

1. A method for control of an oxygen tank (1) for aircraft (10), implemented by a processor (12) onboard the aircraft (10), where the method comprises the following steps:
measuring (20) periodically a current value (Vₙ) of an oxygen volume in the tank (1) and saving the current value (Vₙ) in a database;
calculating (40) an average oxygen consumption flow rate (Q_{n,k}) during an observation period from current values (Vₙ) stored in the database;
comparing (80) said average flow rate (Q_{n,k}) with a preset average flow-rate limit;
detecting a possible state of active oxygen consumption from the tank (1) during the observation period; and
reporting (70) a leak in the tank, if the average oxygen consumption flow rate (Q_{n,k}) is over said preset average flow-rate limit and if no active consumption state was detected during the observation period.

2. The method according to claim 1, comprising, after powering down and restoring power to the onboard processor (12), a step of calculation of values of the oxygen volume in the tank (1) that were not measured between powering down and restoring power, using a final measured value before powering down (Vₙ) and a first measured value after restoring power (Vₙ′).

3. The method according to claim 1 further comprising steps of:
calculating (30) a short-term flow rate (Qₙ) based on the difference between the current value (Vₙ) and an immediately preceding value (Vₙ₋₁); and
recording the short-term flow rate (Qₙ) in the database;
where the step of detecting a possible state of active oxygen consumption from the tank is based on the short-term flow rates (Qₙ) recorded in the database.

4. The method according to claim 3, wherein each value of the short-term flow rate (Qₙ) is compared to a preset short-term flow-rate limit, and a leak may be reported if the short-term flow-rate value (Qₙ) exceeds said short-term flow-rate limit.

5. The method according to claim 1, further comprising the following steps:
measuring the temperature (Tₙ) in the tank (1), or in the neighborhood of the tank, simultaneously with each oxygen volume (Vₙ) measurement (20) in the tank (1); and
calculating, for each calculated average flow rate (Q_{n,k}), a variation of the temperature (T_{n,k}) over the same observation period, and comparison of the temperature (T_{n,k}) variation to a preset temperature limit;
wherein a leak is only reported if the temperature (T_{n,k}) variation is below the preset temperature limit.

6. The method according to claim 1, further comprising a reinitializations step when an active consumption state or filling of the oxygen tank is detected.

7. The method according to claim 1 wherein the preset average flow-rate limit decreases when the length of the observation period increases.

8. The method according to claim 1, further comprising a step of detection of a support force on the wheels of the aircraft (10) and adjustment of the average flow-rate limit, and also, as applicable, of the temperature limit based on the measured support force on the wheels.

9. The method according to claim 3, further comprising the following steps:
measuring the temperature (Tₙ) in the tank (1), or in the neighborhood of the tank, simultaneously with each oxygen volume (Vₙ) measurement (20) in the tank (1); and
calculating, for each calculated average flow rate (Q_{n,k}), a variation of the temperature (T_{n,k}) over the same observation period, and comparison of the temperature (T_{n,k}) variation to a preset temperature limit;
wherein a leak is only reported if the temperature (T_{n,k}) variation is below the preset temperature limit.

10. The method according to claim 3, further comprising a reinitializations step when an active consumption state or filling of the oxygen tank is detected.

11. The method according to claim 3 wherein the preset average flow-rate limit decreases when the length of the observation period increases.

12. The method according to claim 3, further comprising a step of detection of a support force on the wheels of the aircraft (10) and adjustment of the average flow-rate limit, and also, as applicable, of the temperature limit based on the measured support force on the wheels.
